(19) United States
(12) Patent Application Publication
(10) Pub. No.: US 2004/0006707 A1
(43) Pub. Date: Jan. 8, 2004

(54) Keyless access authorization control device and identification transmitter therefor

(75) Inventors: Volker Pretzlaff, Iserlohn (DE); Armin von Preetzmann, Castrop-Rauxel (DE); Eduard Bergmann, Ludenscheid (DE)

Correspondence Address: BROOKS KUSHMAN P.C., 1000 TOWN CENTER, TWENTY-SECOND FLOOR, SOUTHFIELD, MI, 48075, US

(73) Assignee: Leopold Kostal GmbH & Co. KG, Ludenscheid (DE)

(21) Appl. No.: 10/601,738

(22) Filed: Jun. 23, 2003

Related U.S. Application Data
(63) Continuation of application No. PCT/EP02/01383, filed on Feb. 9, 2002.

(30) Foreign Application Priority Data
Feb. 15, 2001 (DE) 101 06 956.1

(51) Int. Cl. H04L 9/00; H04K 1/00

(52) U.S. Cl. 713/200; 380/270

(57) ABSTRACT

A keyless access authorization control system includes transceivers and an identification device. The transceivers are assigned to respective objects. The identification device has a base module operable to communicate with the transceivers. For each object the identification device has a respective memory chip containing a code attuned to the object. The identification device further has an object module(s). The object module(s) is assigned to a respective one of the objects and has a memory chip having the code attuned to the respective object. The object module(s) is interchangeably connected to the base module through an interface(s) in order to communicate the code(s) to the transceiver(s) assigned to the object(s).

### CROSS-REFERENCE TO RELATED APPLICATIONS

This is a continuation of International Application PCT/EP02/01383, published in German, with an international filing date of Feb. 9, 2002.

### BACKGROUND OF THE INVENTION

1. Field of the Invention

The present invention relates to a keyless authorized access control device having at least two transceivers and at least one identification device in which each transceiver is assigned to a respective object and each identification device is able to communicate with the transceivers assigned to the objects. The present invention also relates to an identification device for such a keyless authorized access control device.

2. Background Art

Keyless authorized access control devices are used where controlling access by means of a mechanical key is not desired. For example, such authorized access control devices are used in motor vehicles and in households. The intended opening of a respective object, for example the door of a motor vehicle or the garage door of a house, is done by the wireless transfer of the desired command together with a crypto code from an identification device carried by a user to a transceiver assigned to the respective object. If the transceiver assigned to the object receives the code belonging to this transceiver or object, the person carrying the identification device is considered to be authorized to have access to the object. Access to the object is then enabled, for example, by triggering certain actuators to unlock the motor vehicle or open the garage door.

In order to make it unnecessary for a user to carry several identification devices when several keyless authorized access control devices are used, identification devices and corresponding authorized access control devices have been developed which allow a single identification device to be used for an authorized access control query with several objects such motor vehicle, household, and workplace objects.

The previously known devices which allow authorized access control to be performed for several objects using a single identification device function according to the principle that all object transceivers react to the same crypto code. Such devices are disclosed in DE 195 33 309 A1 and DE 198 01 119 C1, for example. The object of DE 195 33 309 A1 involves composing the crypto code of a fixed code and a changing code. Both of these codes are sent together to access an object such as opening a motor vehicle. When such an authorized access control device is used, in order for it also to be possible to give identification devices to users who may only open the house and not the motor vehicle, this authorized access control device has one or more other identification devices which transmit only the changing code.

By contrast, the object of DE 198 01 119 C1 is to limit use by making each identification device switchable in different functional circuits according to the usage authorization. For this purpose, the respective user of the identification device must enter a personal code in the identification device so that the respective functional circuit is released depending on the user's personal authorization. The identification device disclosed in this document allows several functions to be activated in relation to an object so that a user releasing different functional circuits for the object can trigger all or also only some of the functions which can be activated by the identification device. This blocking of individual functions, which are triggered by pressing corresponding buttons on the identification device, is done in the identification device itself.

The disadvantage of these known authorized access control and identification devices is that they use the same crypto code for authorized access to different objects. This is a disadvantage especially for objects having a different life expectancy, such as motor vehicle and household objects, for example. When one of two objects is changed, the crypto code that is used must be reprogrammed in the identification device or the object transceiver. This involves a great deal of effort. For example, if a new motor vehicle is acquired, the motor vehicle changed crypto code can also be used for controlling authorized access to a house.

This is tedious and expensive, especially if authorized access control queries are to be performed for several objects with a single identification device. Furthermore, it is considered unsatisfactory for an authorized access control query for different objects to be performed using one and the same code or, as is the case in DE 195 33 309 A1, with a code that coincides at least partially.

### SUMMARY OF THE INVENTION

Starting from the prior art which has been discussed, the present invention is therefore based on a keyless authorized access control device of the discussed type and an identification device for such an authorized access control device which avoid the disadvantages associated with the prior art.

In the present invention, the identification device includes, for each object, a memory chip containing an encoding attuned to this object. The identification device has a modular construction, including a base module and at least one object module. The base module has electric/electronic transmission and reception means necessary for communication with respective transceivers assigned to the objects. The at least one object module has the memory chip and is connected to the base module through an interface.

The identification device according to the present invention, and accordingly also the authorized access control device having such an identification device, is characterized by a modular construction in which the necessary means of electric/electronic transmission and reception (hardware) is arranged in a base module.

The base module includes one or more interfaces for connecting a chip containing an encoding, which can be a memory chip, for example. The number of such interfaces which the base module has can correspond to the number of different crypto codes to be transmitted with the identification device, or the base module can have one memory chip of its own and one or more other memory chips can be connected through the interfaces.

The modular construction of the identification device, which allows a single authorized access control device to have several identification devices, makes it possible, by appropriate configuration of one or more interfaces, to organize such an identification device so that it can be used to set up and especially to change the authorization of use through the authorized access control device. Here different encodings are used to communicate with the respective transceivers of different objects. It is also entirely possible to use a single code for an access authorization query for different objects. For the case in which one of the objects is replaced, all that is necessary is to replace the chip containing the encoding on the identification device.

One embodiment of the present invention provides that the base module also has the buttons necessary for operating and activating the assigned identification device. Another embodiment of the present invention provides that a chip containing the encoding also has buttons for activating the assigned identification device. In the latter case, the number of activation buttons that an identification device has corresponds to the number of different codes to send. It is expedient for activation buttons to have a different switching feel and/or different ergonomics so that the different buttons can be felt by a user.

### BRIEF DESCRIPTION OF THE DRAWINGS

The present invention is described below using an exemplary embodiment which refers to the attached figures. The figures are as follows:

FIG. 1 illustrates a perspective view of an identification device having a modular construction for a keyless authorized access control device;

FIG. 2 illustrates the base module of the identification device shown in FIG. 1; and

FIG. 3 illustrates top and bottom views of an object module for the identification device shown in FIG. 1.

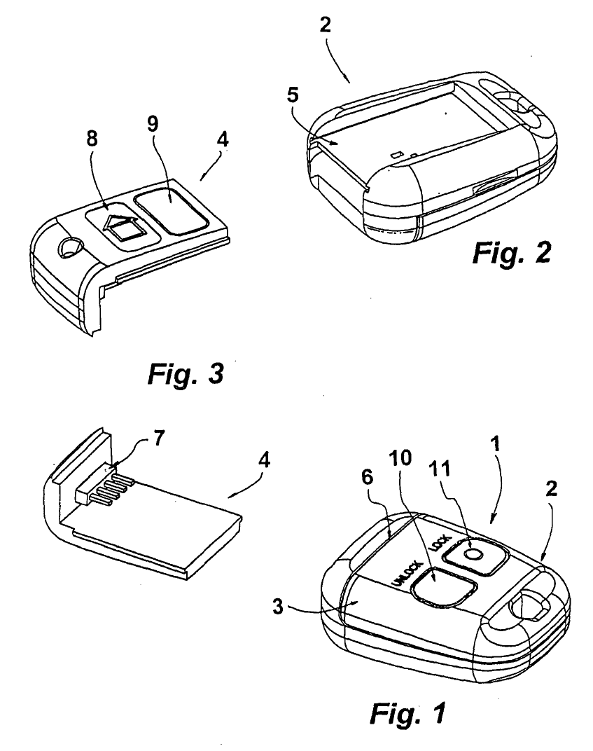

### DETAILED DESCRIPTION OF THE PREFERRED EMBODIMENT(S)

In a keyless authorized access control device, an identification device 1 gives a user authorized access to several objects. Working together with the identification device 1 are transceivers which are configured for objects and with which the means of transmission and reception of the identification device communicate and exchange a code to establish the authorized access.

Identification device 1 has a modular construction and includes a base module 2, which is shown once again by itself in FIG. 2. Base module 2 of identification device 1 contains the necessary means of electric/electronic transmission and reception to enable communication with the respective transceivers which are configured for objects. Identification device 1 also includes object modules 3, 4. Object module 4 is shown again by itself in FIG. 3 from its top and from its bottom.

Object modules 3, 4 are made so that each can be pushed into a corresponding object module receptacle 5, 6 of base module 2, and held locked or latched the corresponding receptacle. Each receptacle 5, 6 of base module 2 has an interface (not shown), which a memory chip assigned to each object module 3, 4 engages into and makes electrical contact with when object module 3, 4 is inserted into the respective receptacle 5, 6. To accomplish this, each object module 3, 4 has a plug-and-socket connector, which is marked with reference number 7 in object module 4. The memory chip itself can be integrated in plug-and-socket connector 7 or located at another place in one of object module 3, 4 and electrically connected with plug-and-socket connector 7.

Each memory chip has a respective crypto code stored in it, which, depending on what object or transceiver communication should take place with, is implemented in the transmission protocol. Therefore, with the identification device 1 having object modules 3, 4 as shown in the figures it is possible to transmit two different crypto codes.

In the sample embodiment shown, buttons 8, 9, 10, 11 necessary for activating identification device 1 are also part of object modules 3, 4. Buttons 8, 9, 10, 11 are made ergonomically different so that a user of identification device 1 can tell without looking which buttons 8, 9, 10, 11 the user is about to press. The interfaces of base module 2 and the memory chip interface that is engaged with it are made in an appropriate way so that buttons 8, 9, 10, 11 are also electrically connected with base module 2 or with the means of transmission and reception contained in the base module.

The description of the present invention shows that the identification device which has been explained makes it is easy for object modules to be exchanged, which also allows the respective encoding to be exchanged. The memory chips can be part of an object module, as shown in the figures, or they can be plugged into the identification device by opening its housing. Such an embodiment allows an identification device to be equipped with many different memory chips to make it possible to carry out an access authorization query on many different objects with different encodings.

In such a case it can be provided that in each case a single transmission protocol is transmitted with all encodings contained in the identification device. The object transceiver recognizes authorized access if the code assigned to this transceiver is received at any place within the protocol. To shorten the transmission protocol, the identification device has a menu mode to select a certain object before pressing the transmit button to make it possible to transfer only the code assigned to this object or the transmission protocol assigned to the object.

List of Reference Numbers

1 Identification device

2 Base module

3 Object module

4 Object module

5 Object module receptacle

6 Object module receptacle

7 Plug-and-socket connector

8 Button

9 Button

10 Button

11 Button

What is claimed is:

1. A keyless authorized access control system, the system comprising:
at least two transceivers, each transceiver being assigned to a respective object; and
an identification device having a base module operable to communicate with the transceivers assigned to the objects, for each object the identification device has a respective memory chip containing a code attuned to the object;
the identification device further having at least one object module, each object module being assigned to a respective object and each object module having the memory chip with the code attuned to the respective object;
each object module being interchangeably connected to the base module through a respective interface in order to communicate the codes to the transceivers assigned to the respective objects.

2. The system of claim 1 wherein:
the base module has a memory chip with a code attuned to one of the objects, the base module communicating the code of the memory chip of the base module to the transceiver assigned to the one object.

3. The system of claim 1 wherein:
the base module has a button operable for activating the identification device to communicate the codes to the transceivers assigned to the respective objects.

4. The system of claim 1 wherein:
each object module has a button operable for activating the identification device to communicate a command with the respective code to the transceiver assigned to the object when the object module is connected to the base module.

5. The system of claim 1 wherein:
each object module has an electronic subassembly relating to the assigned object for carrying out object-specific communication with the transceiver assigned to the assigned object.

6. An identification device for a keyless authorized access control system operable for communicating with transceivers assigned to objects, the identification device comprising:
a base module operable to communicate with the transceivers assigned to the objects; and
at least one object module, each object module being assigned to a respective object and each object module having a memory chip with a code attuned to the respective object assigned with the object module, each object module being interchangeably connected to the base module through a respective interface in order to communicate the codes to the transceivers assigned to the respective objects.

7. The device of claim 6 wherein:
the base module has a memory chip having a code attuned to one of the objects, the base module communicating the code of the memory chip of the base module to the transceiver assigned to the one object.

8. The device of claim 6 wherein:
the base module has a button operable for activating the identification device to communicate one of the codes to the transceiver assigned to the respective object.

9. The device of claim 6 wherein:
each object module has a button operable for activating the identification device to communicate a command with the respective code to the transceiver assigned to the object when the object module is connected to the base module.

10. The device of claim 6 wherein:
each object module has an electronic subassembly relating to the assigned object for carrying out object-specific communication with the transceiver assigned to the assigned object.

11. A keyless authorized access control system, the system comprising:
at least two transceivers, each transceiver being assigned to a respective object; and
an identification device having a base module operable to communicate with the transceivers assigned to the objects, the identification device further having at least two object modules, each object module being assigned to a respective object and each object module having a memory chip containing a code attuned to the respective object, the object modules being interchangeably connected to the base module through respective interfaces in order to communicate the respective codes from the memory chips to the transceivers assigned to the objects.

12. The system of claim 11 wherein:
the base module of the identification device has at least two receptacles with each receptacle receiving one of the object modules in order to interchangeably connect the object modules to the base module through the respective interfaces.

13. A keyless authorized access control system, the system comprising:
at least two transceivers, each transceiver being assigned to a respective object; and
an identification device having a base module operable to communicate with the transceivers assigned to the objects, for each object the identification device having a respective memory chip containing a code attuned to the object, the identification device further having an object module, the object module being assigned to a first one of the objects and having the memory chip having a first code attuned to the first object, the object module being interchangeably connected to the base module through an interface in order to communicate the first code to the transceiver assigned to the first object.

14. The system of claim 13 wherein:
the base module has a receptacle for receiving the object module in order to interchangeably connect the object module to the base module through the interface.

15. The system of claim 13 wherein:
the base module has the memory chip having a second code attuned to a second one of the objects, the base module communicating the second code to the transceiver assigned to the second object.

16. The system of claim 13 wherein:
the object module and the base module have corresponding plug-and-socket connectors in order to interchangeably connect the object module to the base module.

17. The system of claim 13 wherein:
the object module has a button operable for activating the identification device to communicate the first code to the transceiver assigned to the first object when the object module is connected to the base module through an interface.

18. The system of claim 13 wherein:
the object module has at least two buttons, each button is operable for activating the identification device to communicate a respective command with the first code to the transceiver assigned to the first object when the object module is connected to the base module through an interface.

19. The system of claim 13 wherein:
the at least two buttons are ergonomically different from one another to enable a user to distinguish the buttons without viewing the buttons.

20. The system of claim 13 wherein:
each object module has an electronic subassembly relating to the assigned object for carrying out object-specific communication with the transceiver assigned to the assigned object.
